(19) United States
(12) Patent Application Publication
(10) Pub. No.: US 2018/0157747 A1
(43) Pub. Date: Jun. 7, 2018

(54) SYSTEMS AND METHODS FOR AUTOMATED QUERY ANSWER GENERATION

(71) Applicant: Microsoft Technology Licensing, LLC, Redmond, WA (US)

(72) Inventors: Saurabh Kumar Tiwary, Bellevue, WA (US); Mir Rosenberg, Kirkland, WA (US); Jianfeng Gao, Woodinville, WA (US); Xia Song, Redmond, WA (US); Rangan Majumder, Redmond, WA (US); Li Deng, Redmond, WA (US)

(73) Assignee: Microsoft Technology Licensing, LLC, Redmond, WA (US)

(21) Appl. No.: 15/367,630

(22) Filed: Dec. 2, 2016

(51) Int. Cl. G06F 17/30; G06N 3/08; G06N 5/04

(52) U.S. Cl. CPC G06F 17/30864; G06N 5/04; G06N 3/08; G06F 17/30654

(57) ABSTRACT

Systems and methods for automated generation of new content responses to answer user queries are provided. The systems and methods for automated generation of new content responses answer user queries utilizing deep learning and a reasoning algorithm. The generated response is composed of new content and is not merely cut or copied information from one or more search results. Accordingly, the systems and methods for automated generation of new content responses provide tailored query specific answers that can be long and detailed including several sentences of information or that can be short and concise, such as “yes” or “no.” The ability of the systems and methods described herein to create or generate new content in response to a user query improves the usability, improves the performance, and/or improves user interactions of/with a search query system.

### BACKGROUND

Online content searching is a process of searching for and retrieving requested information based on a user query utilizing a search application running on a client computing device, such as a laptop or a smart phone or accessed by a client computing device running over one or more servers. An online search is conducted through one or more search engines, which are programs running on one or more remote servers. The search engines search for documents or website links for specified keywords and return a list of the documents and/or links where the keywords were found and present these result to the user.

It is with respect to these and other general considerations that aspects disclosed herein have been made. Also, although relatively specific problems may be discussed, it should be understood that the aspects should not be limited to solving the specific problems identified in the background or elsewhere in this disclosure.

### SUMMARY

In summary, the disclosure generally relates to systems and methods for automated generation of new content responses to answer user queries. The systems and methods for automated generation of new content responses answer user queries utilizing deep learning and a reasoning algorithm. The generated response or answers are composed of new content and is not merely cut or copied information from one or more search results. Accordingly, the systems and methods for automated generation of new content responses provide tailored query specific answers that can be long and detailed including several sentences of information or that can be short and concise, such as “yes” or “no.” The ability of the systems and methods described herein to create or generate new content in response to a user query improves the usability, improves the performance, and/or improves user interactions of/with a search query system.

One aspect of the disclosure is directed to a system for automated query answer generation. The system includes at least one processor and a memory. The memory encodes computer executable instruction that, when executed by the at least one processor, are operative to:
receive a query;
send the query to a search engine;
receive an enriched query from the search engine;
encode the enriched query into a query vector utilizing deep learning;
receive search results based on the enriched query from the search engine;
encode the search results into a result vector utilizing the deep learning;
form a reasoned vector by analyzing the query vector and the result vector over a vector space utilizing a reasoning algorithm;
decode the reasoned vector into a natural language answer utilizing the deep learning; and
provide the natural language answer in response to the query.
   The natural language answer is a composition of new content.

In yet another aspect of the invention, the disclosure is directed to a system for automated query answer generation. The system includes at least one processor and a memory. The memory encodes computer executable instruction that, when executed by the at least one processor, are operative to:
receive a query;
encode the query into one or more query vectors utilizing deep learning;
encode all passages in a data repository into one or more result vectors utilizing the deep learning;
analyze the one or more query vectors and the one or more result vectors over a vector space utilizing a reasoning algorithm to form a reasoned vector;
decode the reasoned vector into a natural language answer utilizing the deep learning; and
provide the natural language answer in response to the query.
   The natural language answer is a composition of new content.

In another aspect, a method for automated generation of new content answers is disclosed. The method includes:
receiving, at a server, a query from a client computing device;
sending the query to a search engine;
encoding the query into a query vector utilizing deep learning;
receiving search results based on the query from the search engine;
encoding the search results into a result vector utilizing deep learning;
creating a reasoned vector by analyzing the query vector and the result vector over a vector space utilizing a reasoning algorithm;
decoding the reasoned vector into a natural language answer; and
sending instruction from the server to the client computing device to provide the natural language answer to a user in response to the query.
   The natural language answer is a composition of new content.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive embodiments are described with reference to the following Figures.

FIG. 1A is a schematic diagram illustrating a query answer system on a client computing device, in accordance with aspects of the disclosure.

FIG. 1B is a schematic diagram illustrating a query answer system on a server computing device being utilized by a user via a client computing device, in accordance with aspects of the disclosure.

FIG. 2 is a simplified schematic block diagram illustrating the workflow of a query answer system in response to receiving a user query, in accordance with aspects of the disclosure.

FIG. 3 is a schematic diagram illustrating the work flow of a query answer system in response to a received user query, in accordance with aspects of the disclosure.

FIG. 4 is a block flow diagram illustrating a method for automated generation of new content answer, in accordance with aspects of the disclosure.

FIG. 5 is a block diagram illustrating example physical components of a computing device with which various aspects of the disclosure may be practiced.

FIG. 6A is a simplified block diagram of a mobile computing device with which various aspects of the disclosure may be practiced.

FIG. 6B is a simplified block diagram of the mobile computing device shown in FIG. 6A with which various aspects of the disclosure may be practiced.

FIG. 7 is a simplified block diagram of a distributed computing system in which various aspects of the disclosure may be practiced.

FIG. 8 illustrates a tablet computing device with which various aspects of the disclosure may be practiced

### DETAILED DESCRIPTION

In the following detailed description, references are made to the accompanying drawings that form a part hereof, and in which are shown by way of illustrations specific aspects or examples. These aspects may be combined, other aspects may be utilized, and structural changes may be made without departing from the spirit or scope of the present disclosure. The following detailed description is therefore not to be taken in a limiting sense, and the scope of the present disclosure is defined by the claims and their equivalents.

As discussed above, search engines search for documents or website links based on specified keywords form a user query and return a list of the documents and/or links where the keywords were found and present these result to the user. However, people use search engines and/or personal assistants to ask various questions for open domains. Users expect search engines to be able to answer their questions and help them be more productive by completing their task. However, the ability to answer any question from an open domain algorithmically has several challenges. For example, a system needs to comprehend all the written knowledge on the web, have a natural language understanding of the question, filter the web to only the relevant responses, reason over those responses, and then summarize the response into one or more readable sentences. Further, maintenance of complex search query search systems are often difficult to maintain.

As such, while currently utilized search engines or digital assistants search for the most relevant documents and/or even display passages from within these relevant documents in response to a user query, these search tools are not capable of synthesizing or generating new content based on the retrieved search results to efficiently and concisely answer the user's query. Instead, these query systems must rely on already created content to answer the user query. As such, these previously utilized query systems cannot combine content from different search results and/or compose new content to an answer to the user's query.

Therefore, systems and methods for automated generation of new content responses to answer user queries are disclosed herein. The systems and methods for automated generation of new content responses to answer user queries utilize deep learning and a reasoning algorithm. The generated response is composed of new content and is not merely cut or copied information from one or more search results. Accordingly, the systems and methods for automated generation of new content responses provide tailored query specific responses or answers that can be long and detailed including several sentences of information or that can be short and concise, such as “yes” or “no.” The ability of the systems and methods described herein to create or generate new content in response to a user query improves the usability, improves the performance, and/or improves user interactions of/with a search query system.

For example, in response to a user query that recites, “Are carrots always orange?”, previous utilized query response systems would find the most relevant documents, links, and/or website and then display a relevant passage from these search results. For example, the Google Search Engine may quote a specific passage from treehugger.com that recites, “At this time, the Dutch were primarily known as carrot farmers. And they grew carrots in the traditional hues of purple, yellow, and white. In the 17th century, a strain of carrot was developed that contained higher amounts of beta carotene—the first orange carrot.” In contrast, the systems and methods as disclosed here will generate new content in the provided response that is not copied from any specific source from the search results. For example, the systems and method as disclosed herein may respond to the same query by reciting, “No. Carrots may also be purple, yellow, and white.” As such, the systems and method as described herein provide a direct and newly composed answer to the user query instead of copying relevant passages from retrieved search results as performed by previously utilized query search systems.

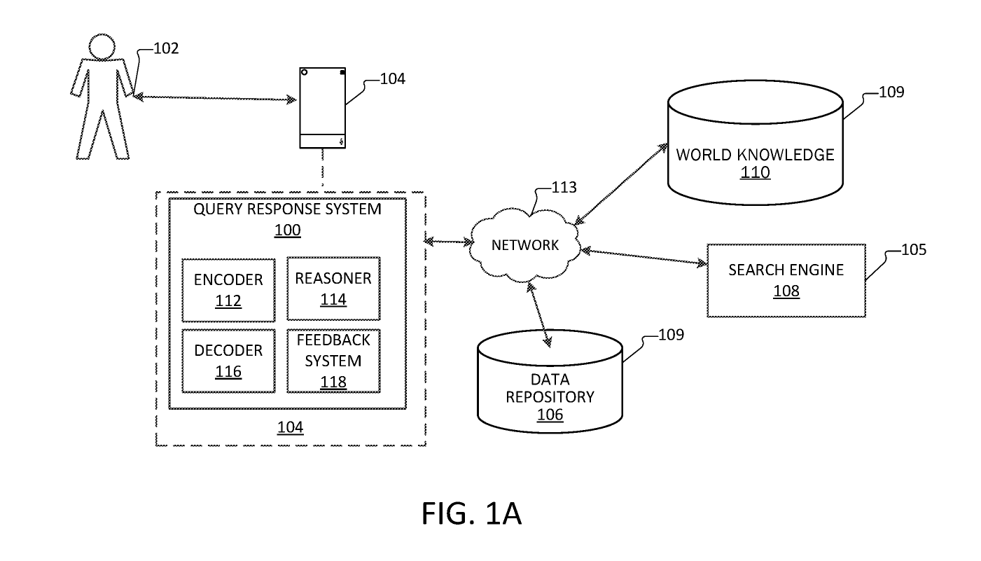

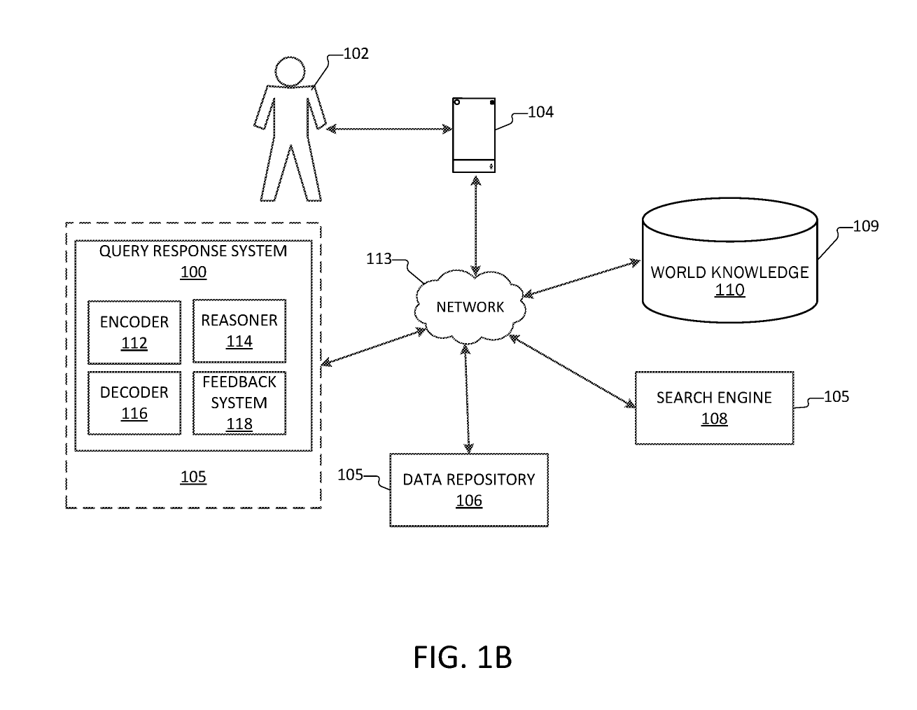

FIGS. 1A and 1B illustrate different examples of a query answer system 100. The query answer system 100 is a system for generating new content to response to a received user query. The query answer system 100 includes an encoder 112, a reasoner 114, and/or a decoder 116. In some aspects, the query answer system 100 also includes a feedback system 118.

In some aspects, the query response system includes a search engine 108. In alternative aspect, the query answer system 100 does not include a search engine 108. In other aspects, the query answer system 100 does not include a search engine 108 but communicates with a search engine 108 through a network 113. In some aspects, the network 113 is a distributed computing network, such as the internet. The search engine 108 may search world knowledge 110 through the network 113 for web pages, passages, and/or other information based on user queries. In other aspects, the search engine 108 may search one or more predetermined data repositories 106.

In some aspects, the query answer system 100 may also utilize or communicate with a data repository 106 through a network 113. In other aspects, the query answer system 100 may on the same client computing device 104 or server computing device 105 as the one or more data repositories 106. The data repository 106 may be any destination for data storage, such as databases, websites, electronic documents, and/or etc. For example, the data repository 106 may be an electronic document such as a word processing document, spreadsheet, a slide deck, etc. In another example, the data repository 106 may be an enterprise system, such as user's private work network or a business enterprise system. In other examples, the data repository 106 may be any information stored on one or more client computing devices associated with a user. In other examples, the data repository 106 includes one or more predetermined databases, websites, and/or knowledge backends. In some aspects, the one or more data repositories 106 are selected by the user 102. In other aspects, the data repositories 106 are preconfigured into the query answer system 100 by the creator of the query answer system 100. Accordingly, the world knowledge 110 and/or the data repository 106 may be or include one or more databases 109.

In some aspects, the query answer system 100 is implemented on the client computing device 104 as illustrated in FIG. 1A. In a basic configuration, the client computing device 104 is a computer having both input elements and output elements. The client computing device 104 may be any suitable computing device for implementing the query answer system 100. For example, the client computing device 104 may be a mobile telephone, a smart phone, a tablet, a phablet, a smart watch, a wearable computer, a personal computer, a gaming system, a desktop computer, a laptop computer, and/or etc. This list is exemplary only and should not be considered as limiting. Any suitable client computing device 104 for implementing the query answer system 100 may be utilized.

In other aspects, the query answer system 100 is implemented on a server computing device 105, as illustrated in FIG. 1B. The server computing device 105 may provide data to and/or receive data from the client computing device 104 through a network 113. In further aspects, that query answer system 100 is implemented on more than one server computing device 105, such as a plurality or network of server computing devices 105. In some aspects, the query answer system 100 is a hybrid system with portions of the query answer system 100 on the client computing device 104 and with portions of the query answer system 100 on the server computing device 105.

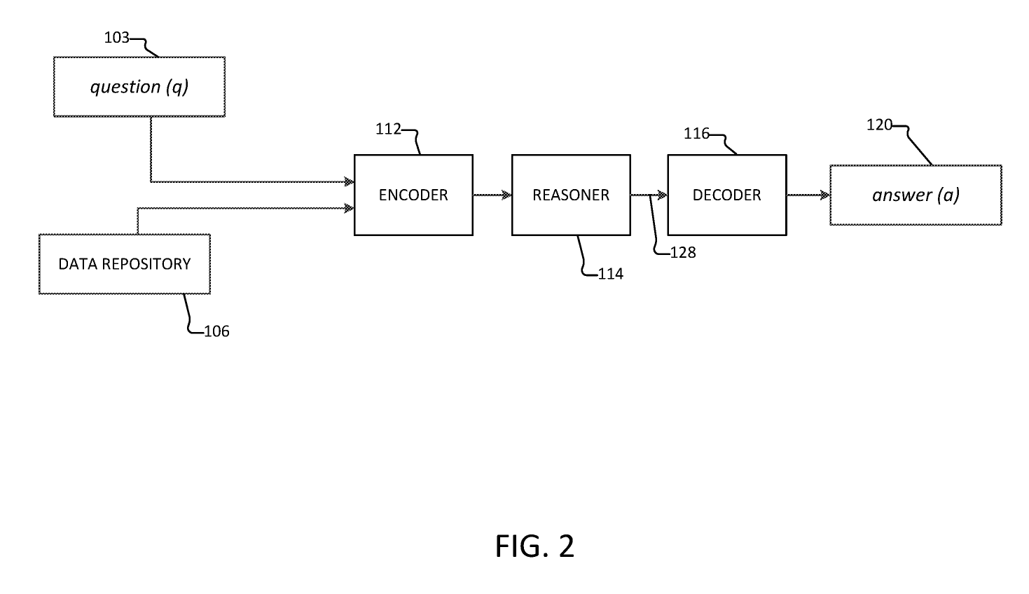

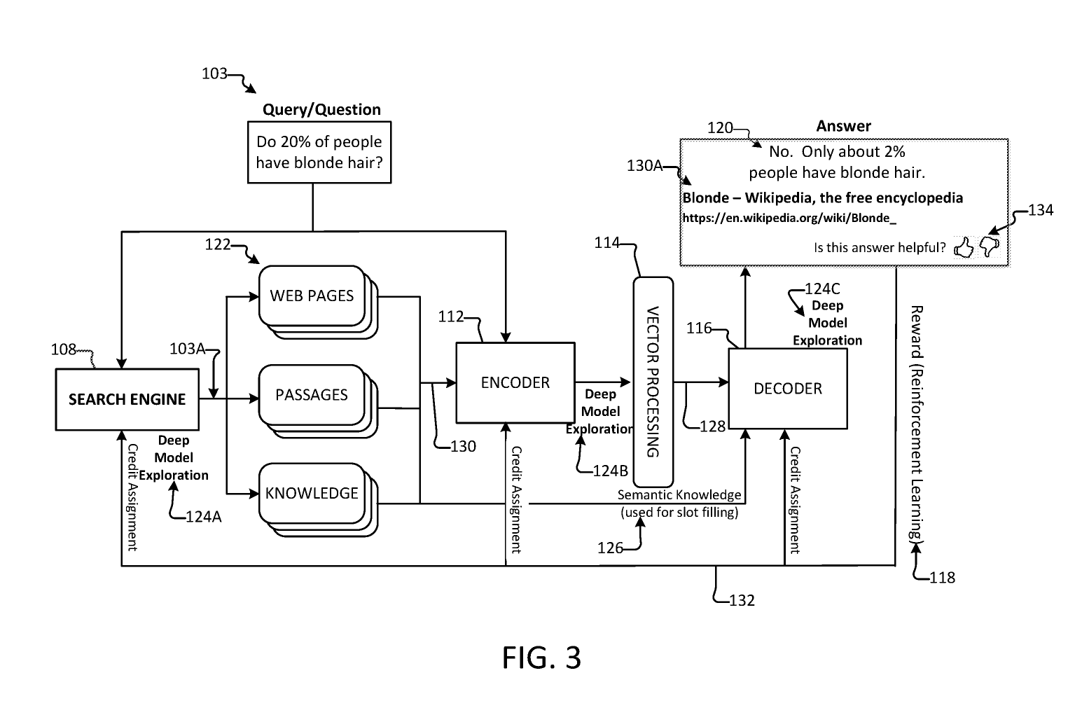

FIGS. 2 and 3 each illustrate an example of a simplified schematic block diagram illustrating the workflow of a query answer system 100 in response to receiving a user query 103, in accordance with aspects of the disclosure. As discussed above and as shown in FIGS. 1A-3, the query answer system 100 includes an encoder 112, a reasoner 114, and a decoder 116. In the example illustrated in FIG. 2, the query answer system 100 does not utilize and/or include a search engine 108. Alternatively, in the example illustrated in FIG. 3 the query answer system 100 communicates with and/or utilizes a search engine 108. In this example, the query answer system 100 communicates with search engine 108 through the network 113. In the example illustrated in FIG. 3, the search engine 108 is separate and distinct from the query answer system 108. In other words, the search engine 108 illustrated in FIG. 3 is not part of the query answer system 100.

As illustrated in FIGS. 2 and 3, the query answer system 100 receives a query 103 from the user 102. The query 103 may be any question, search, or information request by the user 102. The user 102 may input the query 103 into the user interface of the client computing device 104. The query answer system 100 may be part of this same client computing device 104 as illustrated in FIG. 1A or may receive the query 103 from the client computing device 104 through the network 113 as illustrated in FIG. 1B.

In some aspects, the user query 103 is not enriched. In other aspects, the query 103 is enriched utilizing world knowledge 110 and/or one or more data repositories. World knowledge 110 as utilized herein includes any information that can be accessed utilizing a network connection, such as search engines and databases. In some aspects, the query 103 is enriched by the query answer system 100. In other aspects, the query 103 is sent to a system separate from the query answer system 100 for enrichment, such as the search engine 108. For example, a “Starbucks” query element can be searched to determine that “Starbucks” is a coffee shop. In this embodiment, the “Starbucks” query element is enriched by tagging this query element as a “coffee shop.” As such, each of the query elements is tagged with related information or descriptive details to form an enriched query 103A (also referred to as enriched query elements). In some aspects, the query 103 is enriched utilizing deep learning. For example, the element of the query 103 may be enriched utilizing a recurrent neural network (RNN).

In aspects where a search engine 108 is utilized. The search results 122 from the search engine 108 are collected by the query answer system 100. The term collect as utilized herein refers to the active retrieval of information and/or to the passive receiving of information. The search results 122 may be any information contained on one or more specific data repositories or may be any information contained in world knowledge 110. For example, the search results 122 may include web pages, passages, electronic documents, and/or other knowledge, such as learning algorithms, semantic knowledge 126, etc. Semantic knowledge 126 as utilized herein includes slot filling information. In some aspects, the deep learning techniques utilized to decode the reasoned vector may utilize semantic knowledge to decode the reasoned vector 128.

The query 103 or the enriched query 103A is collected by the encoder 112. The encoder 112 encodes the query 103 or the enriched query 103A into one or more query vectors utilizing deep learning. In other words, the encoder 112 converts the natural language elements of the query 103 or enriched query 103A into one or more numeric vectors. The encoder 112 also collects the results 130. The results 130 as utilized herein to refer to all of the information in one or more data repositories 106 and/or to all of the information contained in any collected search results 122 from the search engine 108. The data repositories 106 as utilized herein are not searched by the query answer system 100. The query answer system 100 just utilizes any information found in the one or more data repositories 106 as the results 130 as illustrated by FIG. 2. The encoder 112 encodes the results 130 into one or more result vectors utilizing deep learning. As such, the encoder 112 converts all of the natural language elements in the results 130 into one or more numeric vectors.

The deep learning may utilize machine learning techniques and/or statistical modeling techniques. The deep learning learns or improves through use and/or based on received user feedback. In some aspects, the deep learning is a RNN.

The reasoner 114 collects the one or more query vectors and the one or more result vectors from the encoder 112. The reasoner 114 forms or creates a reasoned vector 128 by analyzing the one or more query vectors and the one or more result vector over a vector space utilizing a reasoning algorithm. In other words, the reasoner 114 mathematically combines the one or more query vectors and the one or more result vectors to create or form a reasoned vector 128. In some aspects, the reasoned vector 128 includes one or more vectors created or formed based on the mathematical combination of the one or more query vectors and the one or more result vectors. As discussed above, the mathematical combination is performed utilizing a reasoning algorithm.

The decoder 116 collects the reasoned vector 128 from the reasoner 114. The decoder 116 decodes the reasoned vector 128 into natural language content to form an answer 120 (also referred to herein as a natural language answer 120) to the query 103. The natural language answer 120 is completely new content. As such, the natural language answer 120 is a new composition of text or information that was not copied from any portions of the one or more the results.

In some aspects, in addition to the natural language answer 120, the decoder may also identify or select one or more relevant items 130A from the results 130 as illustrated in FIG. 3. These relevant items 130A may include passages from results, web pages or other items. The relevant items 130A will list content from the results 130 that has been copied directly from the results 130. As such, the relevant items 130A do not contain new or original content.

In further aspects, the feedback system 118 may generate a feedback request 134 for the natural language answer 120. The feedback request 134 asks the user 102 to input feedback 132 about a provided answer 120. For example, the feedback request 134 may ask the user if the provided answer 120 was helpful or not.

The decoder 116 provides the natural language answer 120 to user 102. In some aspects where the query answer system 100 is not on the client computer device 104, the decoder 116 provides the natural language answer 120 to the user 102 by sending instructions to the client computing 104 to provide the natural language answer 120 to user 102.

The decoder 116 may also provide relevant items 130A and/or a feedback request 134 from the feedback system 118 along with the answer 120 to the user as illustrated in FIG. 3. In aspects where the query answer system 100 is not on the client computer device 104, the decoder 116 provides the relevant items 130A and/or feedback request 134 to the user 102 by sending instructions to the client computing 104 to provide the relevant items 130A and/or feedback request 134 in addition to the natural language answer 120 to user 102.

In some aspects, the feedback system 118 of the query answer system 100 collects user feedback 132 for provided answers 120. The feedback 132 may be explicit or implicit from the user 102. Explicit feedback is when the user provides or inputs a comment about a provided answer 120. For example, the user 102 may select or input that an answer 120 is good or not good. In contrast, implicit feedback is the monitoring of user behavior in response to a provided answer 120. For example, the selection/non-selection, the duration of use, and/or the pattern of use of provided answers 120 or relevant items 130A may be monitored to determine user feedback 132 by the feedback system 118. For instance, a selection of a relevant item 130A under a provided answer 120 may be interpreted by the feedback system 118 that the provided answer 120 was not a sufficient answer to the query. The user feedback 132 is collected and provided to the deep learning algorithms or techniques utilized by query answer system 100 by the feedback system 118. As such, the feedback 132 may be utilized to update or train the deep learning techniques. In some aspects, the query answer system 100 does not collect any feedback 132 regarding a given answer 120.

For example, FIG. 3 illustrates a user query 103 that recites, “Do 20% of people have blonde hair?”. Previously utilized query response systems would find the most relevant documents, links, and/or website and then display a relevant passage from these search results. For example, the Google Search Engine may quote a specific passage from Wikipedia that recites, “At 1-2% of the population, it is the least comment hair color in the world. It is most prominently found in Scotland, Ireland, Whales, and England.” In contrast, the query answer system 100 generates new content in the provided response that is not copied from any specific source from the search results. For example, the query answer system 100 responds to the same query 103 with the following answer 120 reciting, “No. Only about 2% of the population have blonde hair,” as illustrated in FIG. 3. The answer 120 provided in FIG. 3 also includes a link to Wikipedia for blond hair (or a relevant item 130A) and a user feedback request 134. As such, the query answer system 100 provides a direct and newly composed answer 120 to the user query 103 instead of copying relevant passages from retrieved search results as performed by previously utilized query search systems.

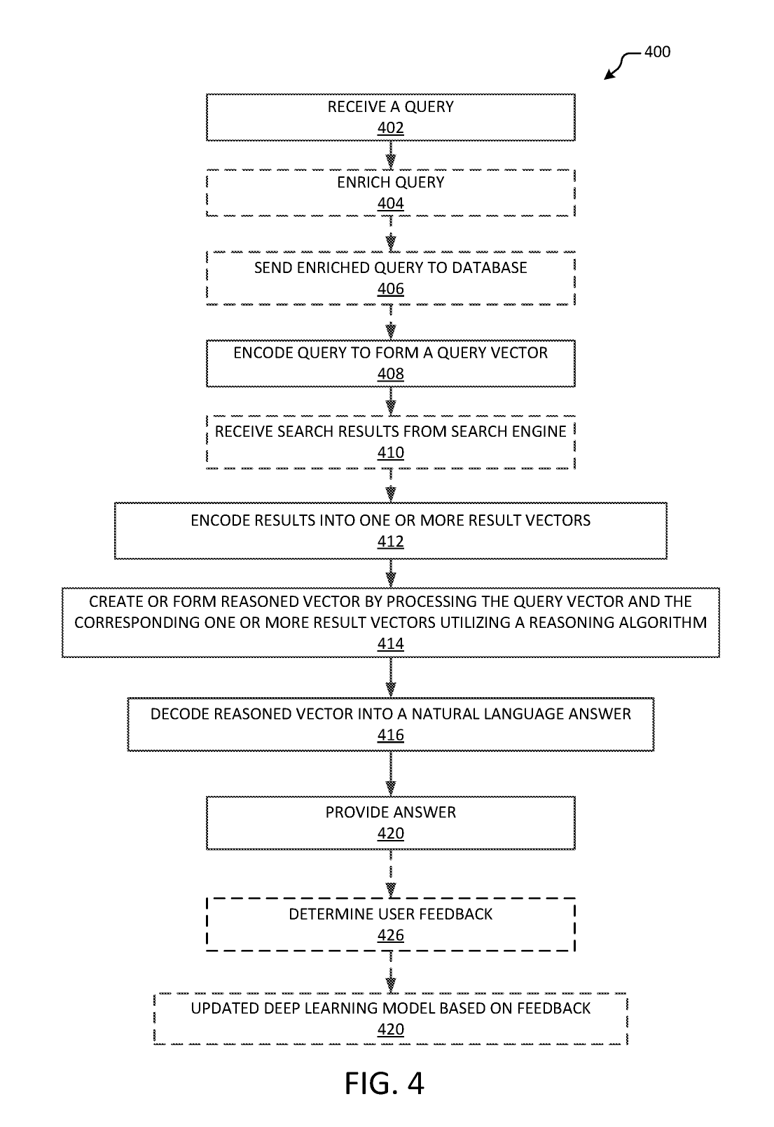

FIG. 4 illustrates a flow diagram conceptually illustrating an example of a method 400 for automated generation of new content answers. In some aspects, method 400 is performed by the query answer system 100 as described above. Method 400 automatically generates new content answers in to response to a received user queries.

Method 400 starts at operation 402. At operation 402, user queries are collected. The queries may be collected from user input into a client device 104. The input may any type of acceptable input for the client computing device, such as text input, voice input, voice input, video input, image input, etc.

In some aspect, method 400 includes operation 404. At operation 404, query elements are enriched with the world knowledge and/or other select one or more data repositories to form enriched query elements or an enrich query. The one or more select data repositories may be determined by the user 102 and/or be preconfigured. In some aspects, the query is enriched utilizing deep learning techniques. In some aspects, the query is sent to a separate system for enrichment. In these aspects, the enriched query may be collected.

In some aspects, method 400 also includes operation 406 and operation 408. At operation 406, the query or the enriched query is sent to a search engine. In some aspects, the search engine enriches a received query. In some aspect, the search engine enriches the query utilizing deep learning techniques. The search engine may enrich the query utilizing world knowledge and/or one or more other select data repositories. The search engine searches the world knowledge and/or one or more other select data repositories based on the query or the enriched query. The one or more select data repositories may be determined by the user 102 and/or be preconfigured. The search engine collects search results based on the query or the enriched query. At operation 408, the search results based on the query or the enriched query are collected from the search engine.

After operation 402, 404, or 406 and 408, then operation 410 is performed during method 400. At operation 410, the query from operation 402 or the enriched query from operation 404 is encoded to form one or more query vectors. The one or more query vectors may be formed or created utilizing deep learning at operation 410. In some aspects, the deep learning is a RNN.

At operation 412 the results are encoded into one or more result vectors. The results may be encoded into the one or more result vectors utilizing deep learning. In some aspects, the deep learning is a RNN. In some aspects, the results are any information contained in one or more date repositories. In other aspects, the results are the received search results. In alternative aspects, the results are any information contained in one or more data repositories and in the received search results. In some aspects, the data repository is any information accessible at operation 412 during method 400. The one or more data repositories are not searched during method 400. In contrast, all information from the one or more data repositories is encoded at operation 412.

Next, at operation 414, one or more reasoned vectors are created or formed by analyzing the one or more query vectors and the corresponding one or more result vectors over a vector space utilizing a reasoning algorithm. The reasoning algorithm may be any suitable reasoning algorithm for mathematically combining the one or more query vectors and the one or more result vectors over a vector space to form a reasoned vector. In some aspects, the reasoned vector includes one or more vectors.

After the performance of operation 414, operation 416 is performed. At operation 416, the reasoned vector is decoded into a natural language answer. The natural language answer is a composition of new content. In other words, the natural language answer is not content that has been copied from the results. In some aspects, the reasoned vector is decoded into a natural language answer utilizing deep learning. In further aspects, the deep learning is a RNN. In other aspects at operation 416, the deep learning techniques utilized to decode the reasoned vector collect and utilize semantic knowledge to decode the reasoned vector.

In some aspects, at operation 416, one or more relevant items from the results are also determined. The relevant items may be passages, website, documents, and/or etc. that are related and/or relevant to the user query. The relevant items may be selected utilizing the reasoned vector and/or the reasoning algorithm.

Next, at operation 418 the natural language answer is provided to the user in response to the received query. In some aspects, at operation 418, relevant items are provided along with answer to the user. In further aspects, the natural language answer is provided to the user by sending instructions to a client computing device to provide the natural language answer to the user. The client computer device may provide the answer to the user via any known suitable output, such as voice output, image output, text output, video output, and/or etc. For example, the client computing device may display the natural language answer as text on a user interface at operation 418.

In some aspects, method 400 includes operation 420 and 422. At operation 420, user feedback is monitored or determined for the provided answer. As discussed above, the user feedback may be implicit or explicit. In some aspects, at operation 420, a feedback request is generated and provided to the use with answer. The feedback is collected at operation 420. At operation 422, the collected feedback is utilized to update and/or train any of the deep learning algorithms and/or techniques. This training and/or updating based on user feedback allows the deep learning techniques to improve and become effective with each use.

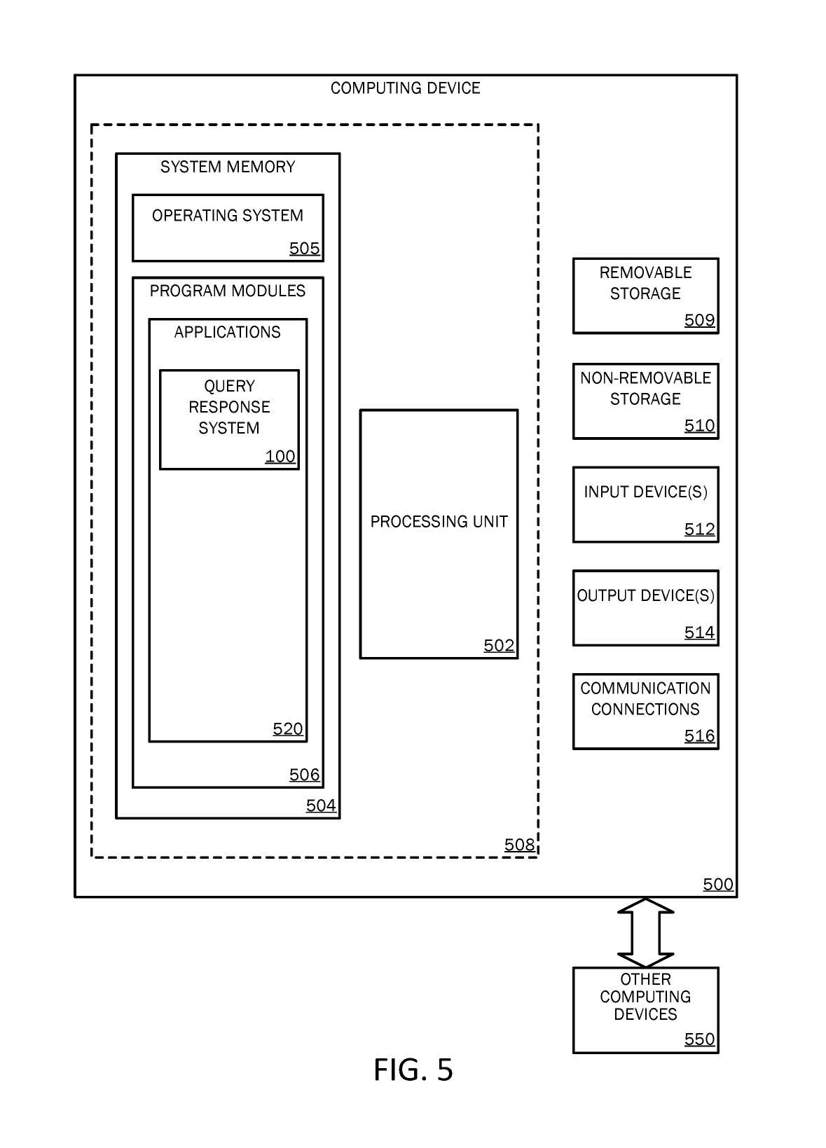

FIGS. 5-8 and the associated descriptions provide a discussion of a variety of operating environments in which aspects of the disclosure may be practiced. However, the devices and systems illustrated and discussed with respect to FIGS. 5-8 are for purposes of example and illustration and are not limiting of a vast number of computing device configurations that may be utilized for practicing aspects of the disclosure, described herein.

FIG. 5 is a block diagram illustrating physical components (e.g., hardware) of a computing device 500 with which aspects of the disclosure may be practiced. For example, the query answer system 100 could be implemented by the computing device 500. In some aspects, the computing device 500 is a mobile telephone, a smart phone, a tablet, a phablet, a smart watch, a wearable computer, a personal computer, a desktop computer, a gaming system, a laptop computer, and/or etc. The computing device components described below may include computer executable instructions for the query answer system 100 that can be executed to employ method 400 to for automated generation of new content answers in response to received user queries.

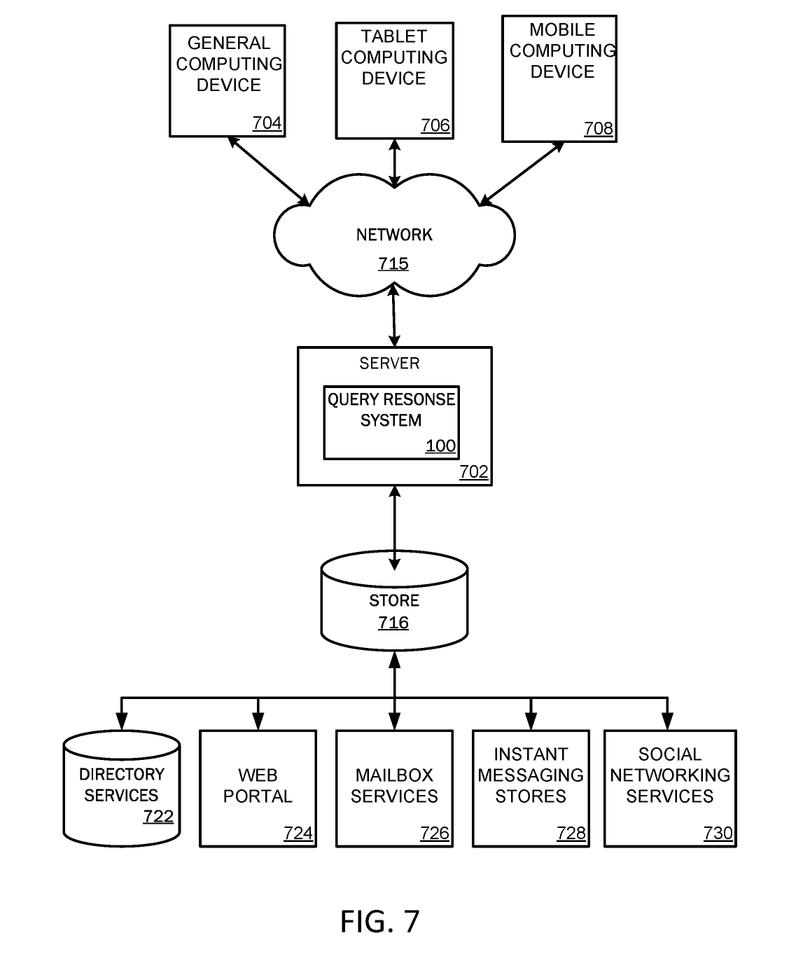

In a basic configuration, the computing device 500 may include at least one processing unit 502 and a system memory 504. Depending on the configuration and type of computing device, the system memory 504 may comprise, but is not limited to, volatile storage (e.g., random access memory), non-volatile storage (e.g., read-only memory), flash memory, or any combined of such memories. The system memory 504 may include an operating system 505 and one or more program modules 506 suitable for running software applications 520. The operating system 505, for example, may be suitable for controlling the operation of the computing device 500. Furthermore, aspects of the disclosure may be practiced in conjunction with a graphics library, other operating systems, or any other application program and is not limited to any particular application or system. This basic configuration is illustrated in FIG. 7 by those components within a dashed line 508. The computing device 500 may have additional features or functionality. For example, the computing device 500 may also include additional data storage devices (removable and/or non-removable) such as, for example, magnetic disks, optical disks, or tape. Such additional storage is illustrated in FIG. 5 by a removable storage device 509 and a non-removable storage device 510.

As stated above, a number of program modules and data files may be stored in the system memory 504. While executing on the processing unit 502, the program modules 506 (e.g., the query answer system 100) may perform processes including, but not limited to, performing method 400 as described herein. For example, the processing unit 502 may implement the query answer system 100. Other program modules that may be used in accordance with aspects of the present disclosure, and in particular to generate screen content, may include a digital assistant application, a voice recognition application, an email application, a social networking application, a collaboration application, an enterprise management application, a messaging application, a word processing application, a spreadsheet application, a database application, a presentation application, a contacts application, a gaming application, an e-commerce application, an e-business application, a transactional application, exchange application, a device control application, a web interface application, a calendaring application, etc. In some aspect, the query answer system 100 is utilizes to search for information within the list of above applications.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 500 on the single integrated circuit (chip).

Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 500 may also have one or more input device(s) 512 such as a keyboard, a mouse, a pen, a microphone or other sound or voice input device, a touch or swipe input device, etc. The output device(s) 514 such as a display, speakers, a printer, etc. may also be included. The aforementioned devices are examples and others may be used. The computing device 500 may include one or more communication connections 516 allowing communications with other computing devices 550. Examples of suitable communication connections 516 include, but are not limited to, RF transmitter, receiver, and/or transceiver circuitry, universal serial bus (USB), parallel, and/or serial ports.

The term computer readable media or storage media as used herein may include computer storage media. Computer storage media may include volatile and nonvolatile, removable and non-removable media implemented in any method or technology for storage of information, such as computer readable instructions, data structures, or program modules. The system memory 504, the removable storage device 509, and the non-removable storage device 510 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 500. Any such computer storage media may be part of the computing device 500. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

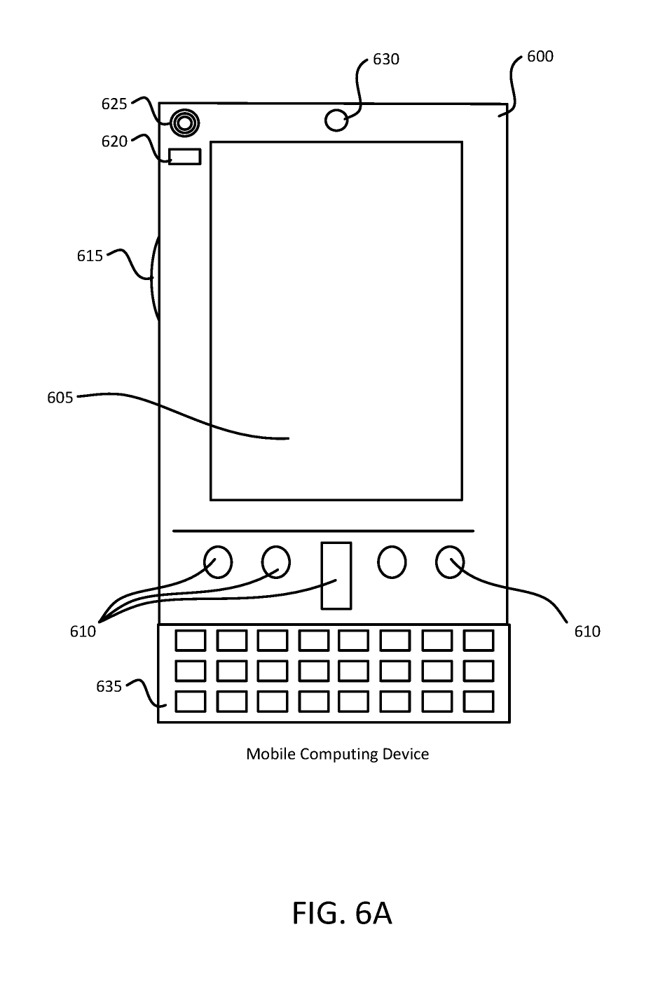

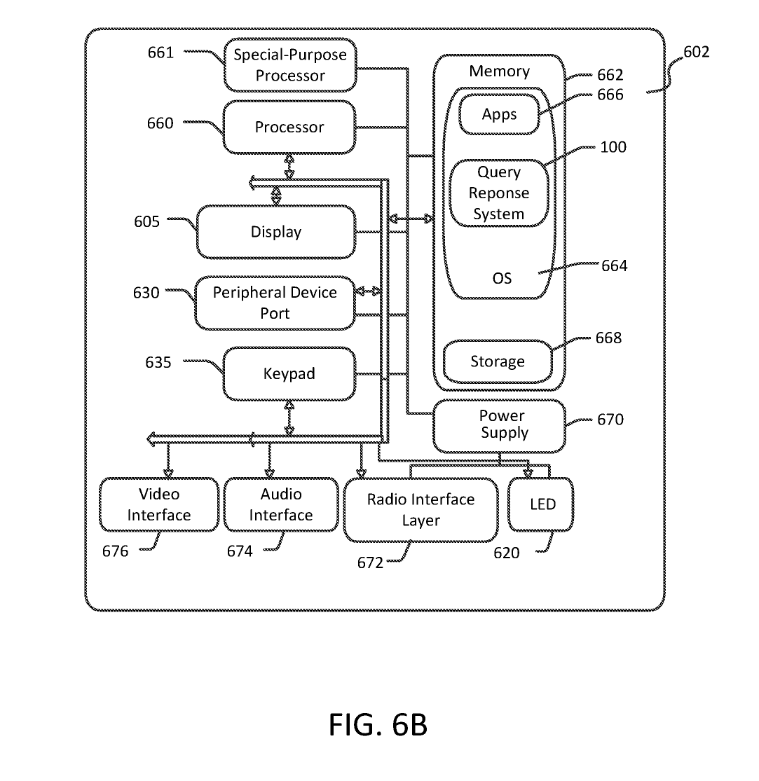

FIGS. 6A and 6B illustrate a mobile computing device 600, for example, a mobile telephone, a smart phone, a tablet, a phablet, a smart watch, a wearable computer, a personal computer, a desktop computer, a gaming system, a laptop computer, or the like, with which aspects of the disclosure may be practiced. With reference to FIG. 6A, one aspect of a mobile computing device 600 suitable for implementing the aspects is illustrated. In a basic configuration, the mobile computing device 600 is a handheld computer having both input elements and output elements. The mobile computing device 600 typically includes a display 605 and one or more input buttons 610 that allow the user to enter information into the mobile computing device 600. The display 605 of the mobile computing device 600 may also function as an input device (e.g., a touch screen display).

If included, an optional side input element 615 allows further user input. The side input element 615 may be a rotary switch, a button, or any other type of manual input element. In alternative aspects, mobile computing device 600 may incorporate more or less input elements. For example, the display 605 may not be a touch screen in some aspects. In yet another alternative aspect, the mobile computing device 600 is a portable phone system, such as a cellular phone. The mobile computing device 600 may also include an optional keypad 635. Optional keypad 635 may be a physical keypad or a “soft” keypad generated on the touch screen display.

In addition to, or in place of a touch screen input device associated with the display 605 and/or the keypad 635, a Natural User Interface (NUI) may be incorporated in the mobile computing device 600. As used herein, a NUI includes as any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence.

In various aspects, the output elements include the display 605 for showing a graphical user interface (GUI). In aspects disclosed herein, the various user information collections could be displayed on the display 605. Further output elements may include a visual indicator 620 (e.g., a light emitting diode), and/or an audio transducer 625 (e.g., a speaker). In some aspects, the mobile computing device 600 incorporates a vibration transducer for providing the user with tactile feedback. In yet another aspect, the mobile computing device 600 incorporates input and/or output ports, such as an audio input (e.g., a microphone jack), an audio output (e.g., a headphone jack), and a video output (e.g., a HDMI port) for sending signals to or receiving signals from an external device.

FIG. 6B is a block diagram illustrating the architecture of one aspect of a mobile computing device. That is, the mobile computing device 600 can incorporate a system (e.g., an architecture) 602 to implement some aspects. In one aspect, the system 602 is implemented as a “smart phone” capable of running one or more applications (e.g., browser, e-mail, calendaring, contact managers, messaging clients, games, and media clients/players). In some aspects, the system 602 is integrated as a computing device, such as an integrated personal digital assistant (PDA) and wireless phone.

One or more application programs 666, the query answer system 100 runs on or in association with the operating system 664. Examples of the application programs include phone dialer programs, e-mail programs, personal information management (PIM) programs, word processing programs, spreadsheet programs, Internet browser programs, messaging programs, and so forth. The system 602 also includes a non-volatile storage area 668 within the memory 662. The non-volatile storage area 668 may be used to store persistent information that should not be lost if the system 602 is powered down. The application programs 666 may use and store information in the non-volatile storage area 668, such as e-mail or other messages used by an e-mail application, and the like. A synchronization application (not shown) also resides on the system 602 and is programmed to interact with a corresponding synchronization application resident on a host computer to keep the information stored in the non-volatile storage area 668 synchronized with corresponding information stored at the host computer. As should be appreciated, other applications may be loaded into the memory 662 and run on the mobile computing device 600.

The system 602 has a power supply 670, which may be implemented as one or more batteries. The power supply 670 might further include an external power source, such as an AC adapter or a powered docking cradle that supplements or recharges the batteries.

The system 602 may also include a radio 672 that performs the function of transmitting and receiving radio frequency communications. The radio 672 facilitates wireless connectivity between the system 602 and the “outside world,” via a communications carrier or service provider. Transmissions to and from the radio 672 are conducted under control of the operating system 664. In other words, communications received by the radio 672 may be disseminated to the application programs 666 via the operating system 664, and vice versa.

The visual indicator 620 may be used to provide visual notifications, and/or an audio interface 674 may be used for producing audible notifications via the audio transducer 625. In the illustrated aspect, the visual indicator 620 is a light emitting diode (LED) and the audio transducer 625 is a speaker. These devices may be directly coupled to the power supply 670 so that when activated, they remain on for a duration dictated by the notification mechanism even though the processor 660 and other components might shut down for conserving battery power. The LED may be programmed to remain on indefinitely until the user takes action to indicate the powered-on status of the device. The audio interface 674 is used to provide audible signals to and receive audible signals from the user. For example, in addition to being coupled to the audio transducer 625, the audio interface 674 may also be coupled to a microphone to receive audible input. The system 602 may further include a video interface 676 that enables an operation of an on-board camera 630 to record still images, video stream, and the like.

A mobile computing device 600 implementing the system 602 may have additional features or functionality. For example, the mobile computing device 600 may also include additional data storage devices (removable and/or non-removable) such as, magnetic disks, optical disks, or tape. Such additional storage is illustrated in FIG. 6B by the non-volatile storage area 668.

Data/information generated or captured by the mobile computing device 600 and stored via the system 602 may be stored locally on the mobile computing device 600, as described above, or the data may be stored on any number of storage media that may be accessed by the device via the radio 672 or via a wired connection between the mobile computing device 600 and a separate computing device associated with the mobile computing device 600, for example, a server computer in a distributed computing network, such as the Internet. As should be appreciated such data/information may be accessed via the mobile computing device 600 via the radio 672 or via a distributed computing network. Similarly, such data/information may be readily transferred between computing devices for storage and use according to well-known data/information transfer and storage means, including electronic mail and collaborative data/information sharing systems.

FIG. 7 illustrates one aspect of the architecture of a system for processing data received at a computing system from a remote source, such as a general computing device 704, tablet 706, or mobile device 708, as described above. Content displayed and/or utilized at server device 702 may be stored in different communication channels or other storage types. For example, various documents may be stored using a directory service 722, a web portal 724, a mailbox service 726, an instant messaging store 728, and/or a social networking site 730. By way of example, the query answer system 100 may be implemented in a general computing device 704, a tablet computing device 706 and/or a mobile computing device 708 (e.g., a smart phone). In some aspects, the server 702 is configured to implement a query answer system 100, via the network 715 as illustrated in FIG. 7.

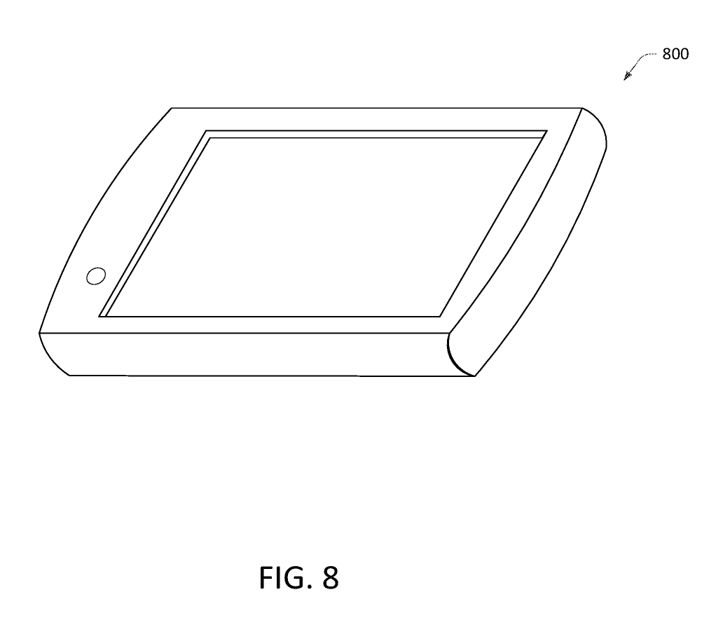

FIG. 8 illustrates an exemplary tablet computing device 800 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which aspects of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Embodiments of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

This disclosure described some embodiments of the present technology with reference to the accompanying drawings, in which only some of the possible aspects were described. Other aspects can, however, be embodied in many different forms and the specific aspects disclosed herein should not be construed as limited to the various aspects of the disclosure set forth herein. Rather, these exemplary aspects were provided so that this disclosure was thorough and complete and fully conveyed the scope of the other possible aspects to those skilled in the art. For example, aspects of the various aspects disclosed herein may be modified and/or combined without departing from the scope of this disclosure.

Although specific aspects were described herein, the scope of the technology is not limited to those specific aspects. One skilled in the art will recognize other aspects or improvements that are within the scope and spirit of the present technology. Therefore, the specific structure, acts, or media are disclosed only as illustrative aspects. The scope of the technology is defined by the following claims and any equivalents therein.

1. A system for automated query answer generation, the system comprising:
at least one processor; and
a memory for storing and encoding computer executable instructions that, when executed by the at least one processor is operative to:
receive a query;
send the query to a search engine;
receive an enriched query from the search engine;
encode the enriched query into a query vector utilizing deep learning;
receive search results based on the enriched query from the search engine;
encode the search results into a result vector utilizing the deep learning;
form a reasoned vector by analyzing the query vector and the result vector over a vector space utilizing a reasoning algorithm;
decode the reasoned vector into a natural language answer utilizing the deep learning,
wherein the natural language answer is a composition of new content; and
provide the natural language answer in response to the query.

2. The system of claim 1, wherein the deep learning is a recurrent neural network.

3. The system of claim 1, wherein the at least one processor is further operative to:
receive user feedback; and
update the deep learning based on the user feedback.

4. The system of claim 3, wherein the at least one processor is further operative to:
generate a feedback request; and
provide the feedback request with the natural language answer,
wherein the user feedback is received in response to the feedback request.

5. The system of claim 1, wherein decode the reasoned vector into the natural language answer utilizing the deep learning comprises:
utilizing semantic knowledge retrieved from world knowledge to provide slot filling.

6. The system of claim 1, wherein the search engine utilizes a deep learning technique to enrich the query.

7. The system of claim 6, wherein the deep learning technique is a recurrent neural network.

8. The system of claim 1, wherein the search engine searches world knowledge.

9. The system of claim 1, wherein the search engine searches one or more predetermined data repositories.

10. The system of claim 1, wherein enrich the query to form the enriched query comprises utilizing world knowledge.

11. A system for automated query answer generation, the system comprising:
at least one processor; and
a memory for storing and encoding computer executable instructions that, when executed by the at least one processor is operative to:
receive a query;
encode the query into one or more query vectors utilizing deep learning;
encode all passages in a data repository into one or more result vectors utilizing the deep learning;
analyze the one or more query vectors and the one or more result vectors over a vector space utilizing a reasoning algorithm to form a reasoned vector;
decode the reasoned vector into a natural language answer utilizing the deep learning, wherein the natural language answer is a composition of new content; and
provide the natural language answer in response to the query.

12. The system of claim 11, wherein the data repository is an electronic document.

13. The system of claim 11, wherein the data repository is a business enterprise system.

14. The system of claim 11, wherein the at least one processor is further operative to:
enrich the query to form an enriched query,
wherein encode the query into the one or more query vectors comprise encoding the enriched query into the query vector.

15. The system of claim 14, wherein enrich the query comprises utilizing world knowledge to enrich the query.

16. The system of claim 15, wherein enrich the query comprises utilizing information from the data repository to enrich the query.

17. The system of claim 15, wherein the deep learning is a recurrent neural network.

18. A method for automated generation of new content answers, the method comprising:
receiving, at a server, a query from a client computing device;
sending the query to a search engine;
encoding the query into a query vector utilizing deep learning;
receiving search results based on the query from the search engine;
encoding the search results into a result vector utilizing deep learning;
creating a reasoned vector by analyzing the query vector and the result vector over a vector space utilizing a reasoning algorithm;
decoding the reasoned vector into a natural language answer,
wherein the natural language answer is a composition of new content; and
sending instruction from the server to the client computing device to provide the natural language answer to a user in response to the query.

19. The method for automated generation of new content answers of claim 18, wherein decoding the reasoned vector into the natural language answer is based is based on the deep learning, and
wherein the deep learning is a recurrent neural network.

20. The method of claim 19, the method further comprises:
enriching the query with world knowledge;
wherein sending the query to the search engine comprises sending the enriched query to the search engine, and
wherein encoding the query into the query vector utilizing the deep learning comprises encoding the enriched query into the query vector utilizing the deep learning.
